(19) United States
(12) Patent Application Publication
(10) Pub. No.: US 2006/0168444 A1
(43) Pub. Date: Jul. 27, 2006

(54) Generic PKI framework

(75) Inventors: David Joel Miller, Burlington, MA (US); Andrew Spencer Myers, Wayland, MA (US); John Clay Richard Wray, Chelmsford, MA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/323,894

(22) Filed: Dec. 30, 2005

Related U.S. Application Data
(60) Provisional application No. 60/645,767, filed on Jan. 21, 2005.

(51) Int. Cl. H04L 9/00

(52) U.S. Cl. 713/158

(57) ABSTRACT

The present invention is a generic public key infrastructure (PKI) framework. A generic PKI framework can include a PKI adapter coupled to a plurality of different PKI certificate authorities (CAs). The PKI adapter can include program code enabled to select a particular one of the different PKI CAs based upon provided request criteria. Also, the generic PKI framework can include a PKI connector coupled to the PKI adapter. The PKI connector can include program code enabled to process requests for certification from PKI clients for respective applications by providing request information from the requests to the PKI adapter.

### CROSS-REFERENCE TO RELATED APPLICATIONS

This patent application claims the benefit under 35 U.S.C. § 119(e) of presently pending U.S. Provisional Patent Application 60/645,767, entitled GENERIC PKI FRAMEWORK, filed on Jan. 21, 2005, the entire teachings of which are incorporated herein by reference.

### BACKGROUND OF THE INVENTION

1. Statement of the Technical Field

The present invention relates to security in network computing and more particular to public key encryption.

2. Description of the Related Art

A Public Key Infrastructure (PKI) provides certificate life-cycle services including certificate creation, renewal and revocation. Applications wishing to take advantage of a Public Key Infrastructure (PKI) generally must code to the specific application programming interface (API) offered by a selected PKI. Consequently, either an embedded PKI ships with the application, or a particular PKI is specified as a companion product to the application so that the API of the selected PKI can be invoked by the application.

Various pluggable architectures are known in the PKI space, most notably the pluggable authentication module (PAM) and the common data security architecture (CDSA). PAM addresses the use of credentials for authentication such as a log-on operation for a computing system, whereas CDSA provides a generic API that includes life-cycle services. Notably, CDSA requires that PKI-specific providers are to be installed on every client system for each external PKI. Furthermore, CDSA requires PKI provider specific knowledge on the part of the application code. Nevertheless, under CDSA, the client can utilize a pluggable API to communicate with a variety of PKIs.

CDSA is deficient in a number of additional ways. For instance, in CDSA version 2.0, applications generally must know the details of the selected providers including the supported interfaces and data structure conventions. Several groups have addressed the deficiencies of CDSA by creating an object-oriented layer on top of CDSA that protects the application from these details and presents a uniform interface to CDSA. In consequence, supporting a new provider requires only an update to an object-oriented shim, and not the calling application.

The Lotus Notes(™) and Lotus Domino(™) certificate authority (CA) manufactured by IBM Corporation of Armonk, N.Y., United States has an architecture that supports client-generated certificate requests for either Notes certificates of X.509 certificates, using a server-based CA process to service both types of request. As part of the CA process, the client code can support both Notes and X.509 certificates by modifying the CA code to accept a standard request format based upon the Internet X.509 public key infrastructure (PKIX) certTemplate for both styles of certificate. As such, no protocol translation for third-party CAs is used. Notwithstanding, in order to extending the CA process to directly use third-party CAs would require the client code to be extended to include a variety of alternate request formats, most notably PKCS10. Also, the server would first have to pick an external CA to use, and then convert the request into whatever form is appropriate for the chosen CA. Accordingly, the complexity of the CA process can become burdensome.

### BRIEF SUMMARY OF THE INVENTION

The present invention addresses the deficiencies of the art in respect to public key encryption and provides a novel and non-obvious method, system and apparatus for a generic PKI framework. In this regard, client application code uses product-defined, PKI-independent APIs to request certificate life-cycle services. A centralized framework process dispatches the request to one of a number of PKI-specific adapter processes, based on a combination of configuration data and the contents of the request, and provides request state-management (workflow) services to the chosen adapter. The chosen adapter transforms the PKI-independent request into a PKI-specific format and communicates with the external PKI to service the request. The results of the external PKI transaction are retrieved by the adapter, transformed back into a PKI-independent form, and passed back to the framework process. The framework process conveys the results back to the original requestor.

The invention describes a framework that permits the majority of the application code to remain PKI-neutral, providing a small number of well-defined places where PKI-specific code must be added. This facilitates the support of a number of different PKIs. Unlike PAM, credentials can be obtained and managed during their life-cycle. Furthermore, unlike CDSA, the PKI-specific code is limited to the server, with client code remaining unaware of which PKI is handling its certificate requests. Finally, unlike CDSA, in the present invention, the client is using a standard protocol to communicate with a server-based dispatcher framework, permitting centralized management of the external PKIs with no requirement to change code running on the client systems if the external PKI is changed

In one claimed embodiment of the invention, a generic PKI framework can include one or more PKI adapters, each coupled to a corresponding, different PKI CA. Each PKI adapter can include program code enabled to select a corresponding different PKI CA based upon provided request criteria. Also, the generic PKI framework can include a PKI connector coupled to the PKI adapters. The PKI connector can include program code enabled to process requests for certification from PKI clients for respective applications by providing request information from the requests to selected ones of the PKI adapters.

In another claimed embodiment of the invention, a method for adapting generic PKI requests for specific PKI CAs can include receiving a generically formatted PKI request from a PKI client for an application, locating a matching PKI adapter for the generically formatted PKI request, invoking the matching PKI adapter, receiving a certificate from a particular PKI CA through the PKI adapter, and returning the received certificate to the PKI client for use in conducting secure communications for the application. The method further can include certifying PKI credentials for the PKI client. Specifically, certifying PKI credentials for the PKI client can include inspecting and validating a PKI credential request provided by the PKI client, generating a request identifier, storing the request identifier in a database, and returning the request identifier to the PKI client for tagging to a certificate for use by the application.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of the generic PKI framework of the present invention;

FIG. 2 is a flow chart illustrating a process for submitting a certificate request to a generic PKI framework;

FIG. 3 is a flow chart illustrating a process for processing a certificate request in a generic PKI framework; and,

FIG. 4 is a flow chart illustrating a process for receiving a certificate request in a generic PKI framework.

### DETAILED DESCRIPTION OF THE PREFERRED EMBODIMENTS

The present invention is a method, system and apparatus for a generic PKI framework. In accordance with the present invention, a framework process can maintain a request database that holds state information relating to in-progress and completed requests. The framework process can provide data access APIs that adapters can use to interrogate or update the state associated with a specific request. A client issuing a certificate request, such as for the creation of a certificate, can create a request message, describing the public key to be certified, the desired name to be associated with the key, and other information related to the desired contents of the certificate.

In a preferred embodiment, the request generated by the client uses industry-standard data structures in the certificate request such as PKCS#10 and the PKIX Certificate Template. The client can submit the request message to the centralized framework process, typically running on a server system supporting a number of clients. The framework process can save the request in the state database, and can examine the request. Using the contents and a configuration file, the framework process can determine the PKI that will service the request. This permits the configuration of multiple PKIs, selected according to the specific request.

For example, the majority of employees of an organization can have their PKI services supplied by a low-cost in-house PKI, while the customer-service department can obtain their certificates from a public external certificate authority (CA), for maximum interoperability with customers. Once a PKI has been chosen, an adapter process is located for that PKI, and the request's database key is sent to that adapter process for servicing. Before forwarding the request to an adapter, the framework may also perform validity checks on the request, for example verifying that the requested name is valid for the requesting client, and that other parameters of the certificate request (such as certificate lifetime) conform to policy.

The adapter can retrieve the request details from the state database, transform the request into the format required by the external PKI, and forward the request to that PKI, using PKI-specific protocols and mechanisms. For example, one CA might use electronic mail to accept certificate requests and issue certificates, while another might use the hypertext transfer protocol (HTTP). When the request is completed by the external PKI, the adapter is responsible for retrieving the results, transforming them into a standard form and depositing the results in the state database.

Retrieving the request details from the state database can involve polling the external PKI for a response. In this regard, the framework periodically can invoke an adapter that has pending requests in order that the adapter may perform this polling. Some CAs may require the adapter to authenticate itself, and take such authentication as evidence that the adapter or framework process have verified its consistency. To support such adapters, the framework process may also provide credential management services.

Periodically, the framework process can check the database for requests that have been serviced by an adapter. When such a request is found, the framework process can return the results of the request to the original requesting client. The framework process may also support an administratively-controlled mode, where a human administrator must approve each certificate request before it is forwarded to an adapter for submission to the external CA. In conjunction with an adapter that authenticates to the external CA, this may permit the CA administrator to delegate approval for certificate requests to the administrator of the framework, if so desired. Even in cases where such manual control of the certificate request process is not desired, an administrative interface to the framework process is useful for monitoring purposes. While the foregoing addresses initial certificate request, the framework also supports renewal and revocation of certificates in a similar fashion.

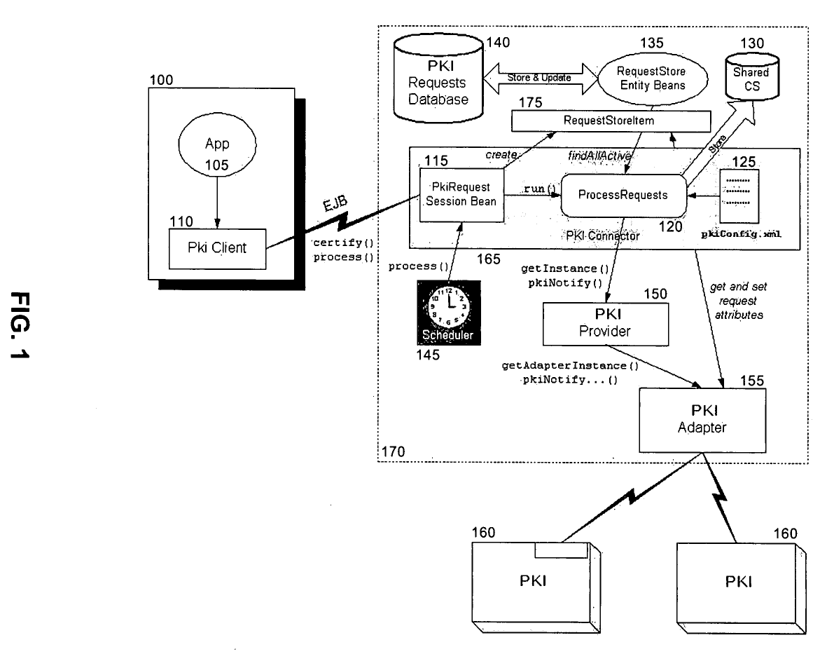

In further illustration, FIG. 1 is a schematic illustration of a generic PKI framework 170. The framework 170 can be communicatively coupled to a client host 100 having each of an application 105 and a PKI client 110. The application 105 can be enabled to generate a certificate in order to initiate the certification process. The PKI client 110 can include program code enabled to build PKI requests and to communicate with a PKIRequest service 115 within a PKI connector 165. For example, the PKIRequest service 115 can be a stateless session enterprise Java bean (EJB) that can include program code enabled to accept and process client requests, including new certification requests which create request entries in the database, and requests to process all active requests.

The PKI connector 165 also can include a RequestStoreItem Interface 175. The RequestStoreItem Interface 175 can provide an interface to RequestStore entity beans 135 which provide access to the store of current PKI requests in a PKI Requests database 140. The PKI Requests database 140 can include a table containing certification requests. The certification requests can be created by the PKI connector 165 when the request is first received, and the status and contents of the table can be updated as the process continues. Also, a network credential store 130 can be provided, into which certified certificates are stored at the end of the process, for subsequent replication to the local credential store within the originating PKI client 110.

For instance, The PKI Requests database 140 can be a persistent store for PKI request throughout a workflow. As such the PKI Requests database 140 can include the following items for each request entry:

Item

Status New/Pending/Issued/Delivered/Rejected/Failed

Sub-status <adapter specific>

Client Request ID Generated by PKIRequest

PKI Request ID Generated by external PKI or PKIAdapter

Action Certify (Recertify, Revoke), Delete original

PKCS10 Generated by client; DER-encoded

Certificate Template Generated by PKIRequest

Credential Reference Provided by client application

Received Certificate Certified credential

Failure Reason Provided by PKIAdapter

Provider/Adapter Indicator

Adapter Data <adapter specific, for state>

Events ARRAY: events and time-stamps for logging and auditing

The PKI connector 165 yet further can include ProcessRequests logic 120. The ProcessRequests logic can include program code, invoked via the PKIRequest service 115, which retrieves all currently active requests from the PKI Requests database 140 and submits the active requests to the appropriate instance of the PKI provider 150. Specifically, a scheduler 145 coupled to the PKIRequest service 115 can trigger the retrieval of the active requests periodically. Notably, the submittal of an request to an appropriate instance of the PKI provider 150 can involve instantiation of the PKI provider 150, and the provision of configuration information 125 to the PKI provider 150.

Finally, the PKI provider 150 can be a component configured to accept a certification request, and to forward the certification request to an appropriate PKI adapter 155, together with relevant configuration information. A single implementation of the PKI provider 150 can be included in the framework 170, and this implementation can be instantiated once for each configured external CA. The PKI provider 150 can be coupled to a PKI adapter 155. The PKI adapter 155 can be a component configured to communicate requests to specific PKI CAs 160, and to receive a certified certificate from specific PKI CAs 160. The implementation of the PKI adapter 155 can be particular to different PKI CAs 160, but if multiple configured CAs employ the same communications prototocol for accepting requests and returning responses, then a single implementation of a PKI adapter 155 can be shared among the multiple configured CAs.

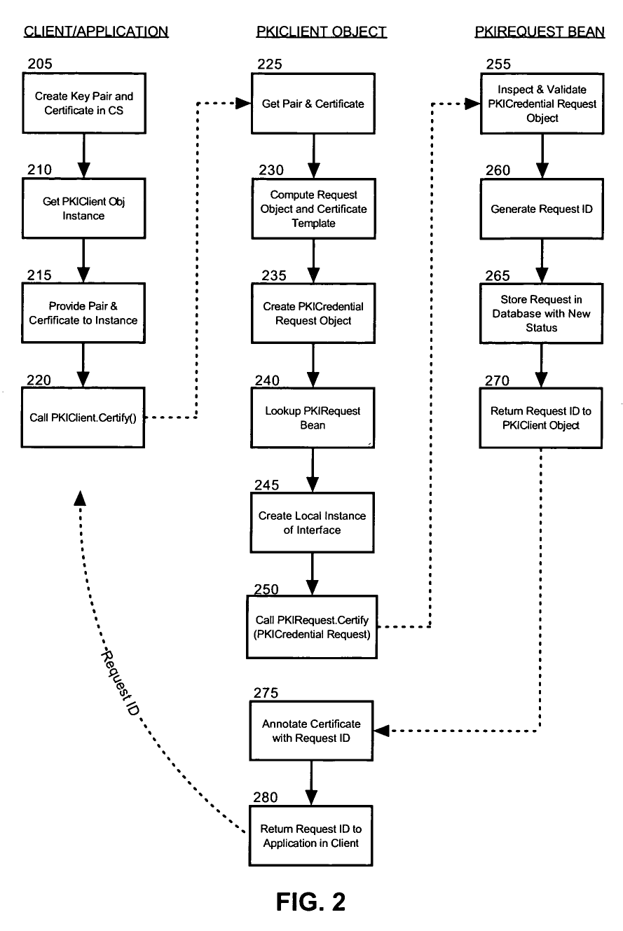

In more particular illustration of the operation of the PKI generic framework 170, FIG. 2 is a flow chart illustrating a process for adapting a certificate request. As shown in FIG. 2, a certification request can begin in block 205 with a client application (end-user or administrator) creating a pair of entries in their credential store. This consists of a Private and Public Key pair stored in their local credential store, and a self-signed certificate stored in a network credential store. The store in which the certificate was created and the location within that credential store of the self-signed certificate form a credential reference, which can allow the PKI framework 170 to later find the certificate to replace it with one obtained from an external CA.

In block 210, the client can retrieve an instance of a PKIClient object and in block 215, the client can provide the key-pair and the self-signed certificate credential reference to the PKIClient object to indicate if the self-signed certificate is to be replaced. In block 220, the client yet further can call a certify( ) method on the PKIClient object. The PKIClient object in turn can retrieve the private/public key pair and X.509 certificate in block 225 and in block 230, the PKIClient object can compute each of a PKCS10 request object, signed using the Private Key, and a certificate template based upon the existing certificate. In block 235, the PKIClient object can create a PKICredentialRequest object, using the PKCS10 object and certificate template.

In block 240, the PKIClient object can look up the PKIRequest bean through the Java naming directory interface (JNDI) and in block 245, the PKIClient object can create a local instance of the remote home interface. In block 250, the PKIClient object can invoke the certify( ) method of the PKIRequest bean on the local instance of the remote home interface, passing in the CredentialRequest object. In block 255, the PKIRequest bean certify( ) method can inspect and validate the CredentialRequest object, and in block 260, the PKIRequest bean certify( ) method can generate a unique request ID. In block 265, the PKIRequest bean certify( ) method can use the RequestStore bean to store the request in the database with a status of ‘New’.

Finally, in block 270, the request ID can be returned to the PKIClient object. In block 275, the PKIClient object can annotate the original certificate with the request ID and in block 280, the PKIClient object can return the request ID to the application. If the PKI framework offers an interface thorugh which status information may be obtained, this request ID can be subsequently used with this interface to obtain progress information about the certificate request. Subsequently, the server scheduler can regularly invoke the process( ) method via the local interface of the PKIRequest session bean, which invokes the run( ) method on the ProcessRequests logic at periodic intervals.

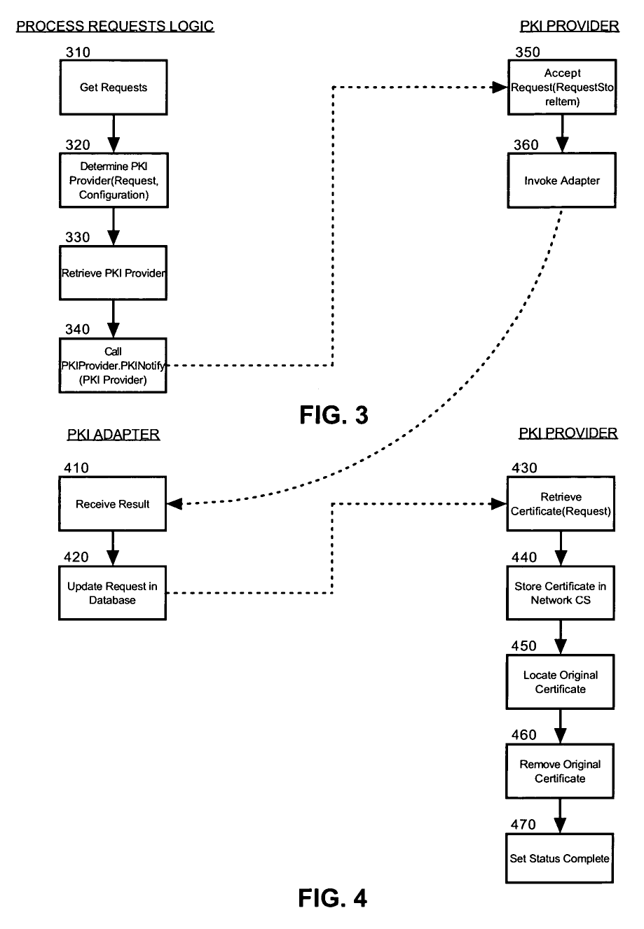

Turning now to FIG. 3, a flow chart is shown which illustrates a process performed at periodic intervals to process PKI requests. Beginning in block 310, the ProcessRequests logic can invoke the findAllActive( ) finder method on the RequestStore entity bean. In block 320, for each located new or pending request, the PKI configuration can be read to determine an appropriate PKI provider and in block 330, an appropriate PKI provider can be retrieved for the request. Notably, the PKI provider can be retrieved via the getInstance( ) method which will create or re-use an instance as appropriate. The PKI provider getInstance( ) method can either return an existing PKI provider instance from its cache for the adapter using the getAdapterInstance( ) method on the concrete adapter defined in the configuration, or create a new PKI provider, cache it and return the PKI provider.

Subsequently, in block 340, the PKINotify( ) method can be invoked on the PKI provider. The PKI provider PKINotify( ) method can accept the request in block 350 via a RequestStoreItem instance based upon the current request status (New, Pending, Custom), and the PKINotify( ) method can invoke the appropriate method on the concrete adapter in block 360. For instance, for a New request status, the PKINotifyNew( ) method can submit the request for certification to the PKI, in the appropriate fashion, receive or generate a PKI request ID, update the status of the request in the database, via the RequestStoreItem interface, to ‘Pending’ and add the PKI request. By comparison, for a PKI Adapter PKINotifyPending( ) method, the PKI can be queried on the status of the pending request to determine if the request has been completed.

Turning now to FIG. 4, a flow chart is shown illustrating a process for receiving a certificate. As indicated above, in block 410 the PKI Adapter can receive from the PKI provider the result of the CA certification. Subsequently, in block 420 the PKI Adapter can update the corresponding request in the database, via the RequestStoreItem interface, with the certified certificate and updates the status to ‘Issued’.

Thereafter, in block 430, the ProcessRequests logic can retrieve the issued certificate and storage details from the request and in block 440, the ProcessRequests logic can store the certificate in the original user's network credential store, based upon the store UUID of the (self-signed) certificate. In block 450, the ProcessRequests logic can locate the original certificate and, depending on whether it is to be replaced or not, in block 460 the ProcessRequests logic can remove the original self-signed certificate. Alternatively, the ProcessRequests logic can remove the original request ID annotation from the self-signed certificate. In either case, in block 470 the ProcessRequests logic can update the status of the request in the database to ‘Complete’.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A generic public key infrastructure (PKI) framework comprising:
a plurality of PKI adapters, each coupled to a different corresponding PKI certificate authority (CA), each PKI adapter comprising program code enabled to select the different corresponding PKI CA based upon provided request criteria; and,
a PKI connector coupled to the PKI adapters, the PKI connector comprising program code enabled to process requests for certification from PKI clients for respective applications by providing request information from the requests to selected ones of the PKI adapters.

2. The PKI framework of claim 1, wherein the PKI connector comprises:
ProcessRequests logic configured to provide the request information from the requests to the PKI adapter; and,
a PKIRequest service configured to receive the requests for certification and to invoke the ProcessRequests logic with the request information.

3. The PKI framework of claim 2, further comprising:
a PKI requests database configured to store PKI requests; and,
a RequestStoreItem interface comprising an interface to access the PKI requests database.

4. The PKI framework of claim 1, further comprising a scheduler programmed to periodically process queued PKI requests in the PKI connector.

5. A method for adapting generic public key infrastructure (PKI) requests for specific PKI certificate authorities (CAs), the method comprising:
receiving a generically formatted PKI request from a PKI client for an application;
locating a matching PKI adapter for the generically formatted PKI request;
invoking the matching PKI adapter;
requesting the certificate from a particular PKI CA via the PKI adapter using a request protocol specific to the particular PKI CA;
receiving a certificate from the particular PKI CA through the PKI adapter; and,
returning the received certificate to the PKI client for use in conducting secure communications for the application.

6. The method of claim 5, wherein receiving the generically formatted PKI request comprises, periodically polling a queue of PKI requests and processing each PKI request in the queue.

7. The method of claim 5, wherein locating a matching PKI adapter for the generically formatted PKI request comprises:
accessing PKI configuration data corresponding to the generically formatted PKI request; and,
identifying the matching PKI adapter using the PKI configuration data.

8. The method of claim 5, further comprising certifying PKI credentials for the PKI client.

9. The method of claim 8, wherein certifying PKI credentials for the PKI client comprises:
inspecting and validating a PKI credential request provided by the PKI client;
generating a request identifier;
storing the request identifier in a database;
returning the request identifier to the PKI client for tagging to a certificate for use by the application; and,
responsive to an issuance of a certificate by an external CA, rendering the issued certificate accessible to the PKI client.

10. The method of claim 5, further comprising supporting request processing for requests selected from the group consisting of requests to renew previously issued certificates and requests to revoke previously issued certificates.

11. A computer program product comprising a computer usable medium having computer usable program code for adapting generic public key infrastructure (PKI) requests for specific PKI certificate authorities (CAs), the computer program product including:
computer usable program code for receiving a generically formatted PKI request from a PKI client for an application;
computer usable program code for locating a matching PKI adapter for the generically formatted PKI request;
computer usable program code for invoking the matching PKI adapter;
computer usable program code for requesting the certificate from a particular PKI CA via the PKI adapter using a request protocol specific to the particular PKI CA;
computer usable program code for receiving the certificate from the particular PKI CA through the PKI adapter; and,
computer usable program code for returning the received certificate to the PKI client for use in conducting secure communications for the application.

12. The computer program product of claim 11, wherein the computer usable program code for receiving the generically formatted PKI request comprises, computer usable program code for periodically polling a queue of PKI requests and processing each PKI request in the queue.

13. The computer program product of claim 11, wherein the computer usable program code for locating a matching PKI adapter for the generically formatted PKI request comprises:
computer usable program code for accessing PKI configuration data corresponding to the generically formatted PKI request; and,
computer usable program code for identifying the matching PKI adapter using the PKI configuration data.

14. The computer program product of claim 11, further comprising computer usable program code for certifying PKI credentials for the PKI client.

15. The computer program product of claim 14, wherein the computer usable program code for certifying PKI credentials for the PKI client comprises:
computer usable program code for inspecting and validating a PKI credential request provided by the PKI client;
computer usable program code for generating a request identifier;
computer usable program code for storing the request identifier in a database;
computer usable program code for returning the request identifier to the PKI client for tagging to a certificate for use by the application; and,
computer usable program code for, responsive to an issuance of a certificate by an external CA, rendering the issued certificate accessible to the PKI client.

16. The computer program product of claim 11, further comprising computer usable program code for supporting request processing for requests selected from the group consisting of requests to renew previously issued certificates and requests to revoke previously issued certificates.
